(19) United States
(12) Patent Application Publication
(10) Pub. No.: US 2003/0065488 A1
(43) Pub. Date: Apr. 3, 2003

(54) Distributed system and method for computer aided multi-component system design

(75) Inventors: John Thaddeus Beckert, Endicott, NY (US); Patricia A. D'Agostino, Spencer, NY (US); John Gregg Yannuzzi, Binghamton, NY (US)

Correspondence Address: PERKINS, SMITH & COHEN LLP, ONE BEACON STREET, 30TH FLOOR, BOSTON, MA, 02108, US

(73) Assignee: Lockheed Martin Corporation

(21) Appl. No.: 10/254,744

(22) Filed: Sep. 25, 2002

Related U.S. Application Data
(60) Provisional application No. 60/324,797, filed on Sep. 25, 2001.

(51) Int. Cl. G06F 17/50

(52) U.S. Cl. 703/1

(57) ABSTRACT

The system and methods of this invention provide specific component design objects that include design guideline properties. The system and methods of this invention also provide means for storing the completed design information upon completion of the design. One embodiment of the method and system of this invention is a distributed method and system utilizing the World Wide Web.

### CROSS REFERENCE TO RELATED APPLICATIONS

This application claims priority of U.S. Provisional Application No. 60/324,797 filed on Sep. 25, 2001, which is herein incorporated by reference.

### BACKGROUND OF THE INVENTION

This application relates the generally to computer aided design, and more specifically to distributed computer aided design of multi-component systems such as material handling systems.

The computer aided design of multi-component systems, such as material handling systems, is usually performed utilizing a dedicated computer aided design program. The use of such programs requires extensive training and experience. The advent of the World Wide Web provided the opportunity to distribute a computer aided design tool to the general public. However, most computer aided design tools continue to follow the single computer/expert user paradigm.

There are some present examples of Web based simple design programs that contain some of the kernels of Web based computer aided design. For example, it is possible to conceptually design the layout of a room by selecting, placing and organizing furniture images on a design area utilizing the Web. The furniture images in that design process do not contain any knowledge of design guidelines. For example, the placement of a chair, a desk and a bookshelf are solely under the control of the user. There are no built-in rules to prevent a user from placing a chair behind a bookshelf, for example.

Some simpler Web based design programs allow a user to select model, options and color of an automobile. In another example of a simple Web based design program, a user can build a computer image of a fashion model, select clothing and view the clothing on the model. While these simple Web based design systems foretell the promise of Web based design, these simple design systems lack the “intelligence” and reporting capabilities needed for a conceptual computer aided design and layout tool.

Some single computer design tools allow the addition of attributes to the component models. The attributes are properties of the component being modeled and they do not include design rules.

There is a need for a design tool that incorporates intelligent components and object-oriented design guidelines. There is also a need for a Web based computer aided design tool that includes design rules in the component models and provides means for reporting and documenting the design.

### SUMMARY OF THE INVENTION

The present invention discloses systems and methods that enable the computer aided design of a multi-component system. The systems and methods of this invention incorporate intelligent components and object-oriented design guidelines. The systems and methods of this invention provide specific component design objects that include design guideline properties. The systems and methods of this invention also provide means for storing the completed design information upon completion of the design. One embodiment of the method and system of this invention is a distributed method and system utilizing the World Wide Web.

The method of this invention for enabling the design of the multi-component system includes providing a menu of component types and, for each of the component types, providing a menu of specific component objects, where the specific component objects include design guideline properties. The menus provide the capability to select, via user input, a component type and to select, via user input, a specific component object. Once the specific component object is selected, an image of the selected specific component object is displayed. The spatial properties of the image of the selected specific component object are, then, selected following user input. The data corresponding to a system design area is provided via user input or obtained from an existing design. The image of the selected specific component object with the selected spatial properties, is, then, placed via user input, on the system design area and moved, following user input, to a desired position in the system design area. If at least one other image of a selected specific component object is present in the system design area, a relationship is established between the image of the selected specific component object and one other image of a specific component object, where the relationship incorporates the design guideline properties. The process is repeated until a completed design has been obtained,

The method of this invention can also include the step of storing, upon completion of the design of the multi-component system, the design information.

In one embodiment, the system of this invention includes one or more client computers, a network, a server computer having an interface for communicating over a network and a multi-component system design generating module, and a database storing user identifying data, design identifying data, multi-component system design data. The multi-component system design generating module is provided to the client computer via the network. In another embodiment, the network is the World Wide Web.

### BRIEF DESCRIPTION OF THE DRAWINGS

FIG. 1 is a flow chart representative of the method of this invention;

FIG. 2 represents a schematic pictorial of one embodiment of the system of the present invention;

FIG. 3 presents a schematic graphical representation of a database of this invention;

FIG. 4 depicts a graphical representation of one embodiment of the input screen as seen by a user;

FIG. 5 depicts another graphical representation of one embodiment of the input screen as seen by a user;

FIG. 6 depicts yet another graphical representation of one embodiment of the input screen as seen by a user;

FIG. 7 depicts still yet another graphical representation of one embodiment of the input screen as seen by a user;

FIG. 8 depicts a graphical representation of one embodiment of the input screen as seen by a user displaying a completed design;

FIG. 9 presents a flow diagram for one embodiment of this invention.

### DETAILED DESCRIPTION OF THE EMBODIMENTS

Systems and methods that enable the computer aided design of a multi-component system are disclosed below. The system and methods of this invention provide specific component design objects that include design guideline properties. The systems and methods of this invention also provide means for storing the completed design information upon completion of the design.

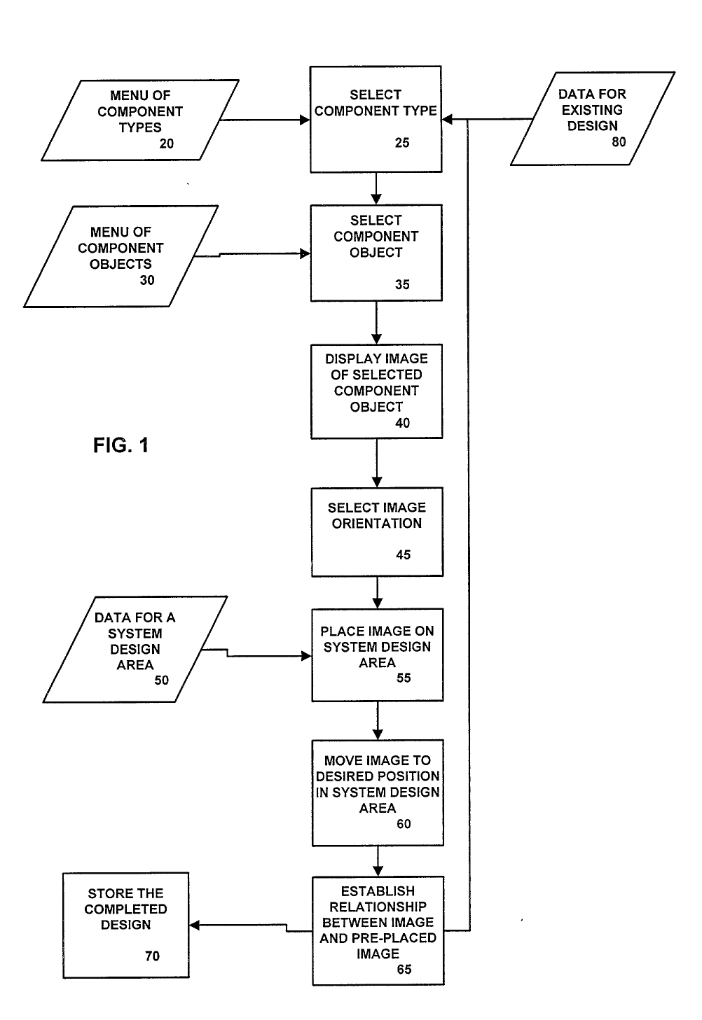

A flow chart of an embodiment of a method of this invention is shown in FIG. 1. Referring to FIG. 1, a menu 20 of component types is provided to a user. The menu 20 is displayed at a Window or Web page available to the user. The user then provides input to select a component type (step 25, FIG. 1). Upon selection of the component type, a menu 30 of component objects is provided to the user. The component objects include design guideline properties. Through user input, a specific component object is selected (step 35, FIG. 1). An image of the selected component object is displayed at the Window or Web page available to the user. An orientation, or similar spatial property, is selected based on user input (step 45, FIG. 1). The data 50 for a system design area is provided by the user. Under user control, the image of the selected object is placed on the system design area (step 55, FIG. 1). Under user control, the image of the selected object is moved to a desired position in the system design area (step 60, FIG. 1). If at least one other image of a component object is present in the system design area, a relationship is established between the image of the selected object and the image of one other object (step 65, FIG. 1). Steps 25 through 65 of FIG. 1 are repeated until a design is completed. Once a design is completed, the completed design is stored in a computer readable medium (step 70, FIG. 1). Optionally, data for an existing design can be retrieved from a storage location (step 80, FIG. 1). The design data includes data corresponding to the retrieved system design area, a number of identifiers of specific component objects, and a location in a retrieved system design area for each one of the specific component objects, where the identifiers correspond to the specific component objects (referred to hereinafter as design data).

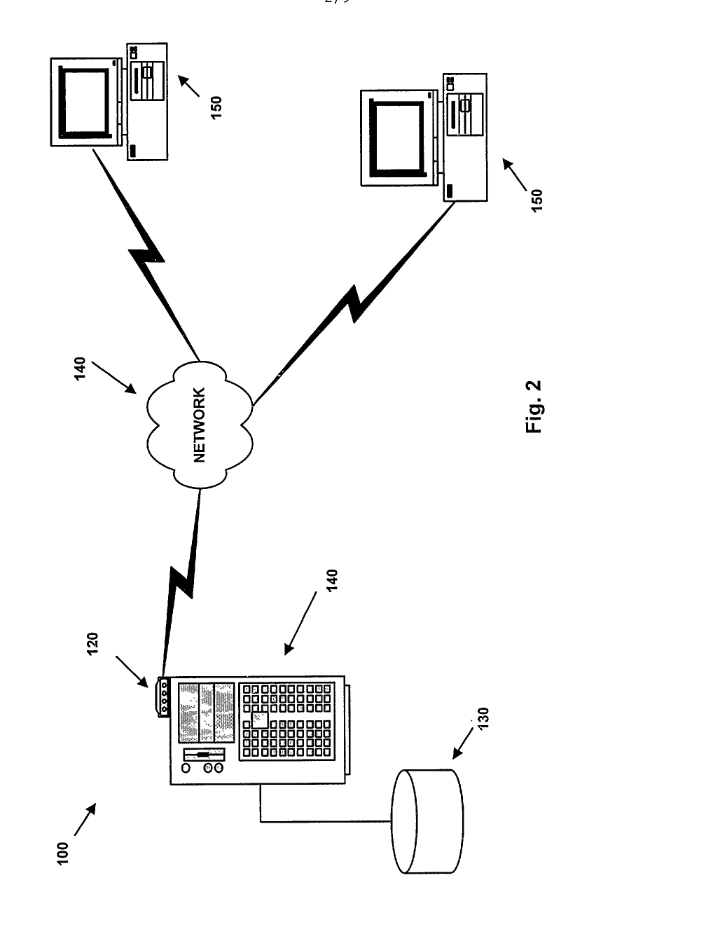

The method of FIG. 1 can be practiced utilizing a single computer. However, the benefits of this invention are best obtained by practicing the method of FIG. 1 in a distributed system. FIG. 2 pictorially represents one embodiment of the system of the present invention. In the embodiment shown in FIG. 2, system 100 includes a server 110 with means 120 for communicating over a network 140, a database 130 accessible from the server 110, and two client computers 150, where the to client computers 150 also have access to network 140. Means 120 include interface circuits and modems needed to communicate over network 140. Network 140 is, in one embodiment, the World Wide Web but could be, in other embodiments, an Intranet or a local area network. Server 110 also includes a multi-component system design generating module (not shown) which would partially reside in a computer usable medium (also not shown) in server 110. The multi-component system design generating module contains computer readable code for implementing the method of FIG. 1. The multi-component system design generating module can be implemented utilizing any of the distributed systems technologies-applet, an ACTIVE X control, third-party controls (e.g., ShockWave™). The server 110 and the client computers 150 include the necessary software components to implement and support a distributed application—for example, DCOM or CORBA, or Web server/browser, application servers (such as ColdFusion™) and third-party applications (e.g., ShockWave™). The multi-component system design generating module and the supporting necessary software components provide means for providing a menu of component types, means for providing, for each of the component types, a menu of specific component objects, where the specific component objects include design guideline properties, means for receiving user input, means for selecting, upon receiving user input, a component type and a specific component object, means for displaying an image of the selected specific component object, means for selecting an orientation of the image of the selected specific component object, means for providing data corresponding to a system design area, means for placing, in the selected orientation, the image of the selected specific component object on the system design area, means for moving the image of the selected specific component object to a desired position in the system design area, and means for establishing, if at least one other image of a selected specific component object is present in the system design area, a relationship between the image of the selected specific component object and one other image of a specific component object, the relationship incorporating the design guideline properties.

The multi-component system design generating module and the supporting necessary software components also provide the ability to store, upon completion of the design of the multi-component system, the design data. The design data can also be retrieved in order to modify an existing design. A notification of design completion can also be provided to the user.

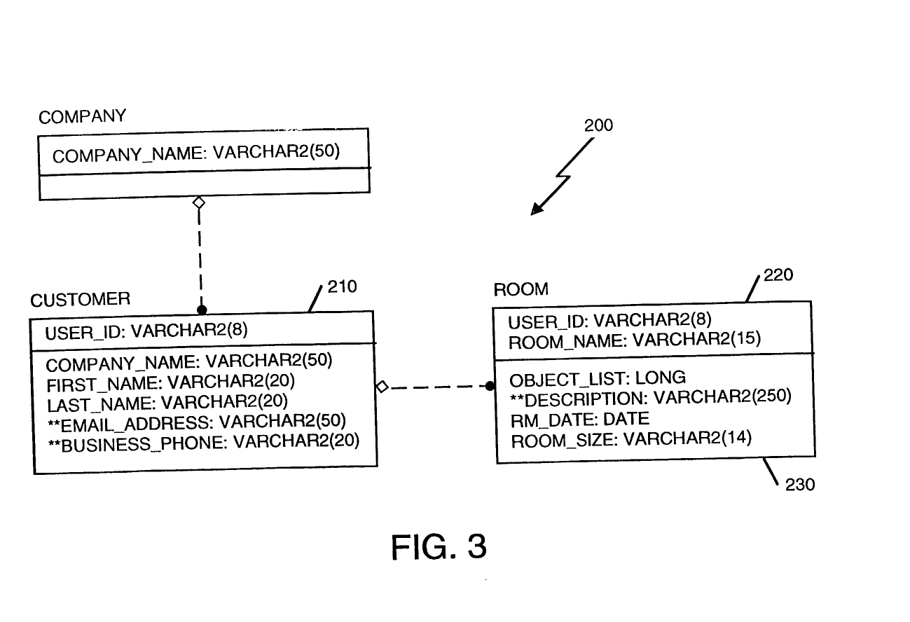

The database 130 stores a structure for describing designs of the multi-component systems. One embodiment of the structure for describing designs of the multi-component systems is shown in FIG. 3. The structure 200 includes user identifying data 210, design identifying data 220, multi-component system design data 230 including an identifier for each of specific component objects, a location in the system design area for each one of the specific component objects, and data corresponding to the system design area, wherein the location of said specific component objects in the system design area conforms to design guideline properties corresponding to each one of said plurality of specific component objects. Table 1 presents an example of an embodiment of the structure stored in database 130 including data corresponding to the system design area, data corresponding to a user, and an object list including an identifier for each one of the specific component objects, a location in a system design area for each one of the specific component objects. This data is used for retrieval and re-creation of the user's designs. This data is also used as the user creates their design using the system. For example (using information provided in table 1), a user may place an object of type 17 on workspace location (30, 100) and then attempt to place an additional object of type 17 on workspace location (150, 100). At this point, the client application searches the nearby workspace to retrieve the adjacent object types which are candidates for association. The client application then compares the spatial and conjunctive parameters for each candidate with the spatial and conjunctive parameters of the last object placed by the user, and determines that the second object of type 17 should be placed exactly next to the first object of type seventeen, and moves it to the proper workspace location of (154, 100).

TABLE 1

| User Identifier | tester01 |
|---|---|
| Design Area Data - Identifier | Candor01 |
| Object List | |
| Specific Component Identifier | Specific Component Location |
| 17 | (30, 100) |
| 17 | (154, 100) |
| 21 | (193, 111) |
| 24 | (239, 105) |
| 24 | (239, 143) |
| 27 | (234, 295) |
| 2 | (290, 104) |

It should be noted that, although numerical characters are used to identify the component in the embodiment above, alphanumerical characters or object names (using the term “object” in the manner used in object oriented languages) are also possible. If numerical characters are used component, a correspondence exists between the numerical characters and the physical nature of the components. The design guidelines are best understood in relation to the physical nature of the components.

The server 110 also includes a user identification module. It should be noted that the user identification module could be similar to that found in password protected Web sites.

In using the system 100 of FIG. 2, a user at client computer 150 contacts the server 110. In one embodiment, the user contacts the server 110 by requesting a Web page. Upon proper identification, via the user identification module, the user receives the multi-component system design generating module, or a portion of the module in other embodiments (for example, embodiments utilizing CORBA). As the user exercises the multi-component system design generating module, the user can retrieve design data in order to modify an existing design. Upon completing a design, the user provides to the server the design data. Both in retrieving the design data and in providing the design data to the server, an embodiment of data structure 200 is sent via the network 140. The data structure 200, when being transmitted via the network 140, is embodied in a carrier wave such as electromagnetic radiation.

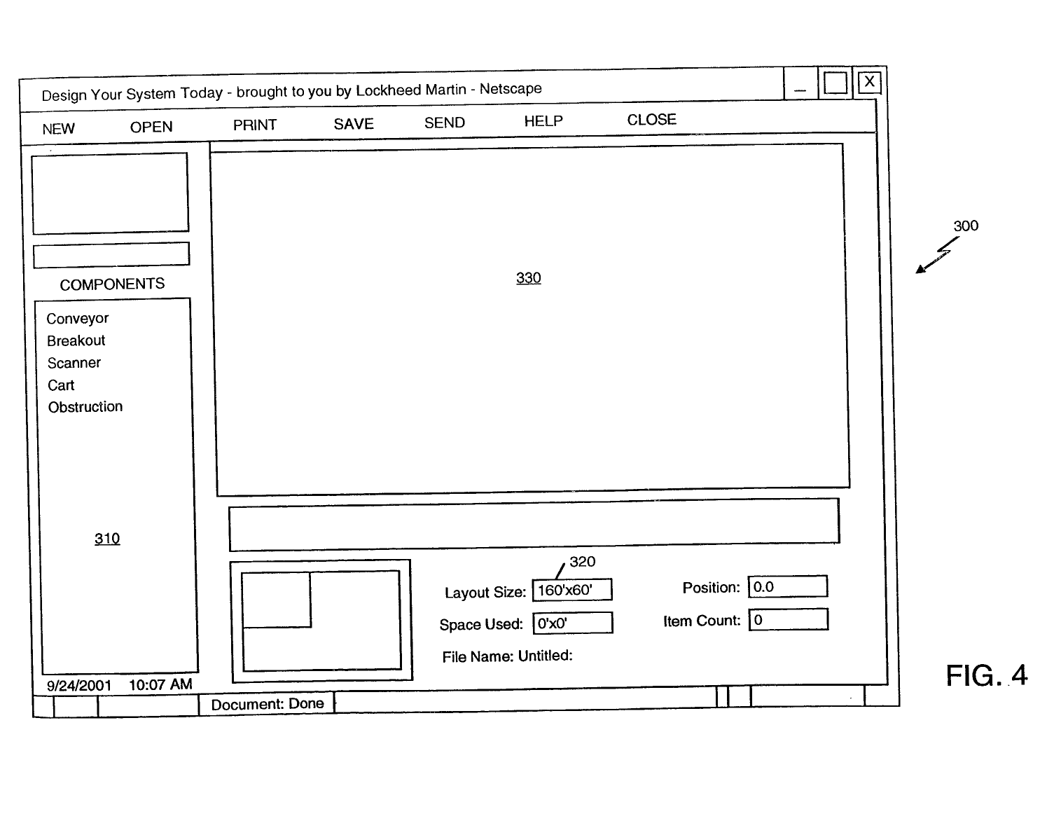

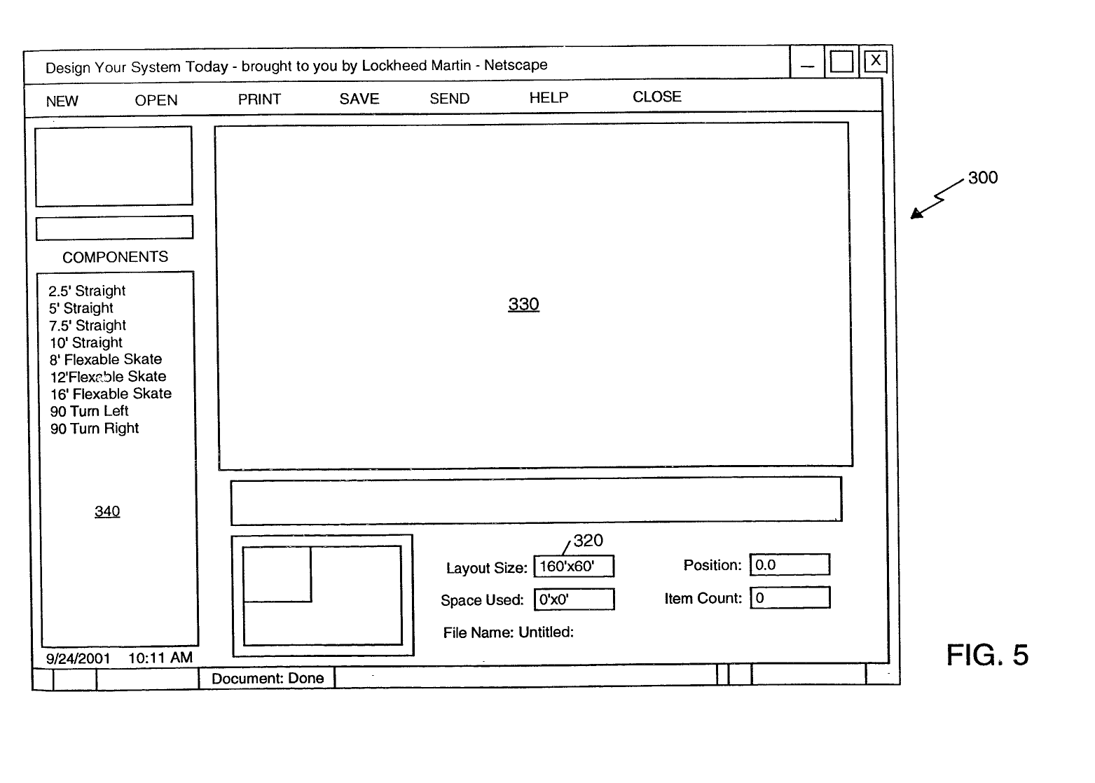

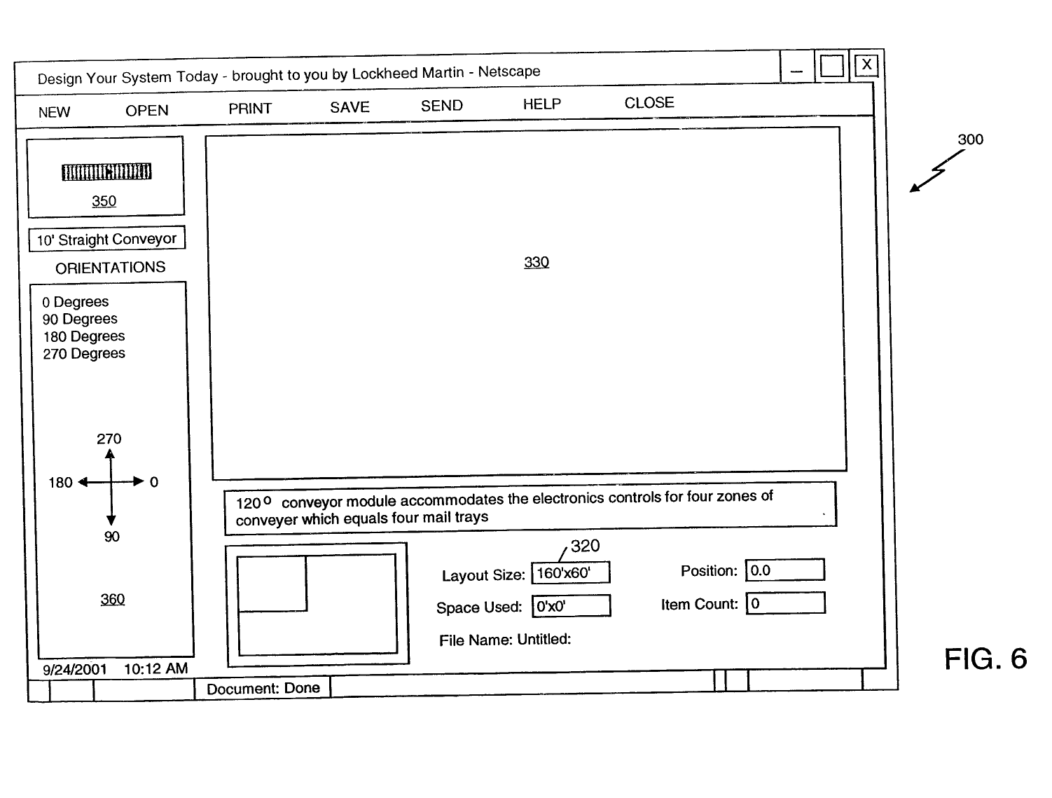

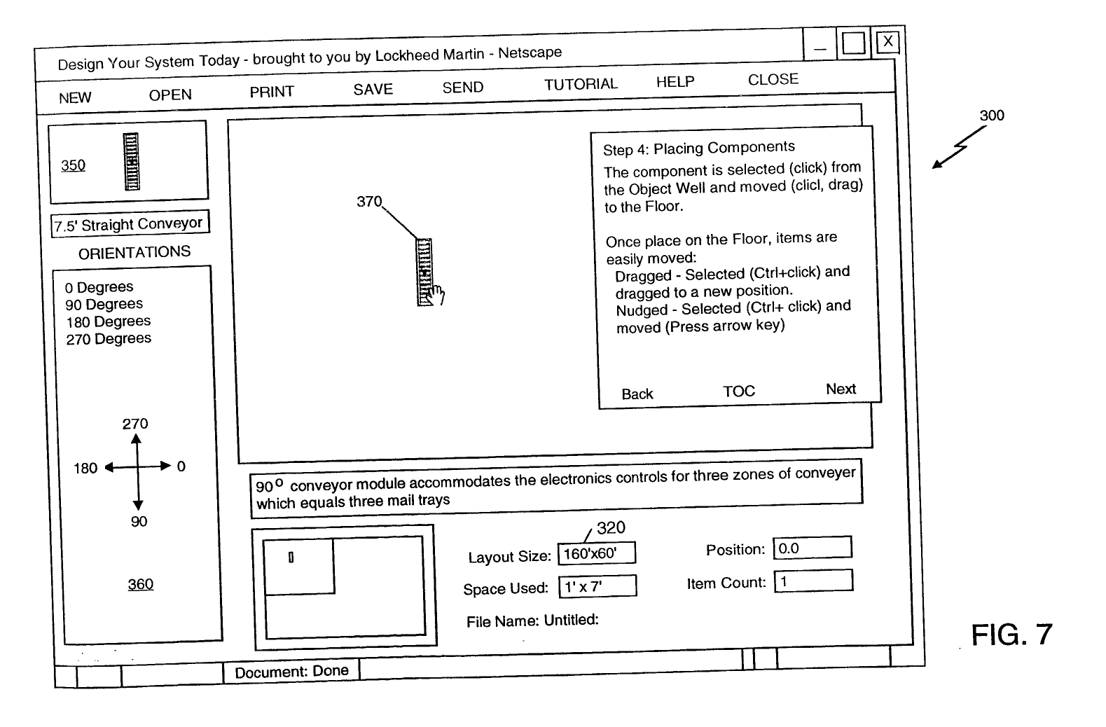

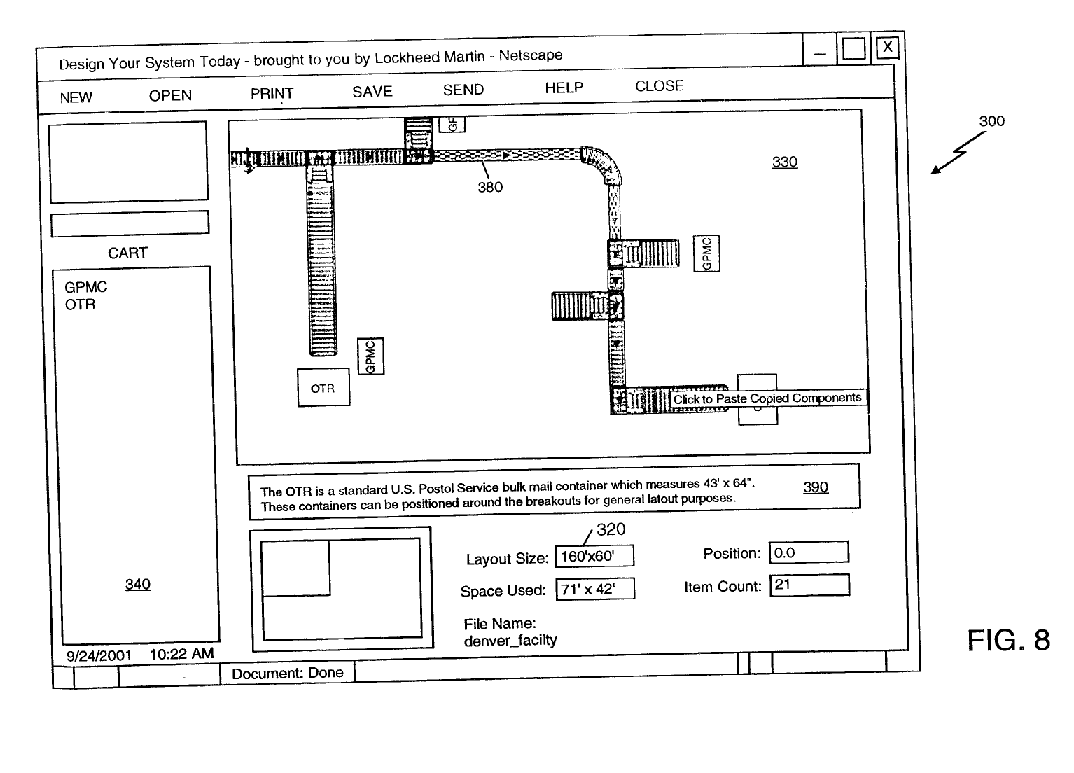

In order to even more clearly understand the present invention, reference is now made to the following illustrative example. Referring again to FIG. 2, the user at client computer 150 sends a request to server 110 via a Web browser. The user receives from server 110 a Web page including access to a user identification module. The Web page at server 110 can be generated by a product, such as ColdFusion™, for building Web sites and serving Web pages. The user provides a user name and password to the server 110. Further identification may be required involving further communication with the server 110. Once the user identity has been verified, the user receives a Web page from the server that gives access to the multi-component system design generating module. A portion of the multi-component system design generating module is provided by the server 110 to the user's client computer 150. The portion of the multi-component system design generating module can be a third-party control (e.g., a module provided in LINGO™ for Shockwave™). As shown in FIG. 4, the user is presented with a web page 300 which includes a menu of component types 310. The web page 300 also includes a window 320 for providing data corresponding to the system design area 330. The user provides data corresponding to the system design area 330 and selects a component type. Upon selecting a component type, the user is presented with a menu of specific component objects 340, as shown in FIG. 5. Upon selecting a specific component object, an image 350 of the selected specific component objects is displayed, as shown in FIG. 6. Also shown in FIG. 6 is a window 360 that allows the user to rotate the image 350. The user then selects the desired orientation of the image 350. The user can then, through a click-and-drag operation, place a copy 370 of the image 350 in the system design area 330, as shown in FIG. 7. Repeating this process starting with a new component type or making copies of the same component, the user obtains a completed design 380 as shown in FIG. 8. Also shown in FIG. 8 is a menu 340 of specific components of component type “CART” and the suggestions 390 stemming from the design guideline rule for specific component “OTR”.

Upon completion of the design, the user can store, at the remote database 130, the user identifying data, design identifying data and the design data. Upon completion of the design, the user can transmit, send, the user identifying data, design identifying data and the design data to predetermined destinations. The user can also obtain documentation of the design, either by printing or by exporting an image of the design as seen in the system design area 330. Printing can be accomplished by means of a print component or sub-module. Exporting an image of the design is also accomplished by means of an exporting component or sub-module. For third party controls, print and exporting components or sub-modules are usually available.

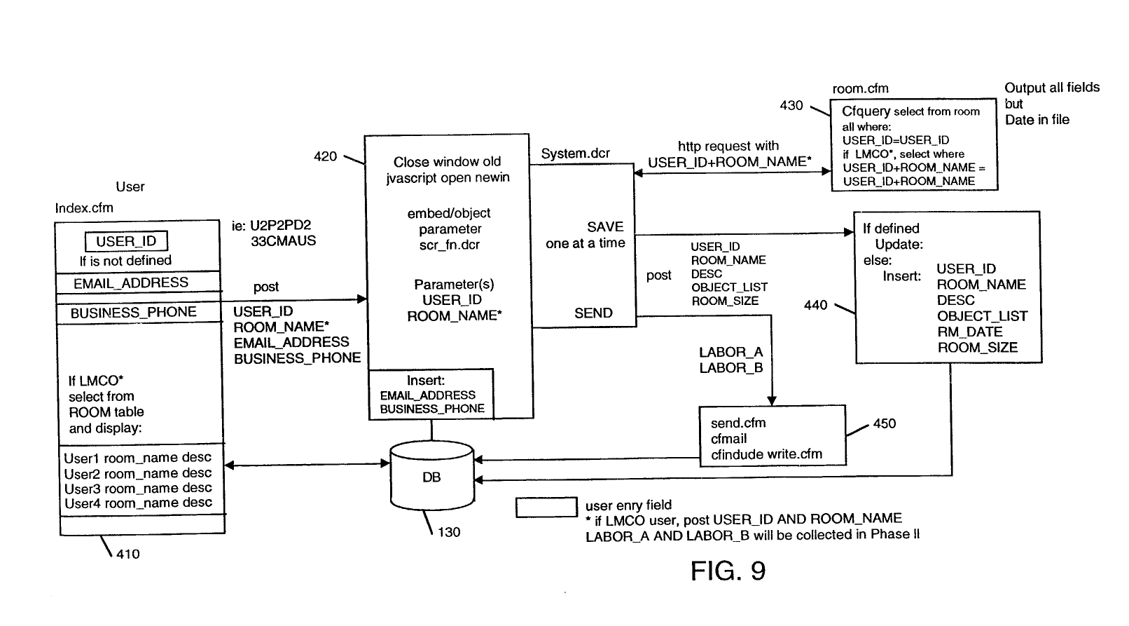

FIG. 9 presents a flow diagram for the above described embodiment of this invention. Referring to FIG. 9, a user identifying mark-up language file 410 (index.cfm) provides the user identification module. For an existing user, the user data can be obtained from the database 130. The user information is communicated to the start-up mark-up language file 420 (start.cfm) which provides the system design generating module (system.dcr). The capability to obtain an existing design and the corresponding design data is provided by the design retrieving mark-up language file 430 (room.cfm). To obtain an existing design, an access code is provided from the web page form (index.cfm->start.cfm) to the system design generating module 420 (system.dcr). An http request is sent to the design retrieving mark-up language file 430 (room.cfm). The design retrieving mark-up language file 430(room.cfm) runs a query to the database 130 returning all the identified designs, ROOM table records, matching that identifying information. The returned information is used to create data structures that contain the design information for each identified design. The user can select one of the data structures (for example, from an OPEN option from a MAIN menu). The selected room data structure is parsed and all design data (size, space used, item count, and file name) and design components objects which were a part of the original design are re-established in the active memory (RAM) of the Client computer 150 (FIG. 2) as the current “active” design. The current “active” design is then displayed in the system design area 330.

After the system design generating module (system.dcr) is exercised and a new completed design is obtained, the design is saved utilizing the design storing mark-up language file 440 (Write_room.cfm). The user identifying data, design identifying data and the design data, inserted or update by means of the design storing mark-up language file 440, is transmitted to the database 130. A user notifying mark-up language file 450 (send.cfm) is utilized to generate and send an e-mail notification of the completion of the design. The email destination can be predefined and contain multiple addresses. The e-mail contains the user identifying data and design identifying data. It also contains the direct hyperlink of that design. The URL contains the user identifying data, USER_ID, and design identifying data, ROOM_NAME. This provides a one click access from the e-mail client to that design. Referring to FIG. 9, when the user selects SAVE, the user identifying data, design identifying data and the design data are stored in database 130. When the user selects SEND, the user identifying data, design identifying data and the design data are stored in database 130 and the notifying e-mail is transmitted to predetermined destinations. In the embodiment shown in FIG. 9, the mark-up language files are ColdFusion Markup Language (CFML) files and the system design generating module (system.dcr) is a ShockWave™ component. The print and exporting components or sub-modules used by the ShockWave™ component are called “Xtras” and are available from third party sources.

In the above described embodiment, the rotation of the image is selected, although, it is well within the purview of this invention that any other spatial property of the image could have been selected. Also, although in the above described embodiment, the notification of design completion was an e-mail, other notification methods can be used. It should also be apparent that, although, in the above described embodiment, specific third party controls and Web server tools were utilized, others can be used. Furthermore, the methods described herein relate to client/server systems and can be used with any technology used to implement client/server systems. For example, it should be apparent that any of the technologies described in R. Orfall and D. Harkey, “Client/Server Programming with Java and CORBA” (ISBN 0-471-24578-X) can be used (R. Orfall and D. Harkey, “Client/Server Programming with Java and CORBA”, particularly, pp. 186-371, and pp.849-883).

In general, the techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to data entered using the input device to perform the functions described and to generate output information. The output information may be applied to one or more output devices.

Elements and components described herein may be further divided into additional components or joined together to form fewer components for performing the same functions.

Each computer program may be implemented in any programming language, such as assembly language, machine language, a high-level procedural programming language, or an object-oriented programming language. The programming language may be a compiled or interpreted programming language.

Each computer program may be implemented in a computer program product tangibly embodied in a computer-readable storage device for execution by a computer processor. Method steps of the invention may be performed by a computer processor executing a program tangibly embodied on a computer-readable medium to perform functions of the invention by operating on input and generating output.

Common forms of computer-readable (computer usable) media include, for example, a floppy disk, a flexible disk, hard disk, magnetic tape, or any other magnetic medium, a CDROM, any other optical medium, punched cards, paper tape, any other physical medium with patterns of holes, a RAM, a PROM, and EPROM, a FLASH-EPROM, any other memory chip or cartridge, a carrier wave, such as electromagnetic radiation or electrical signals, or any other medium from which a computer can read.

Although the invention has been described with respect to various embodiments, it should be realized that this invention is also capable of a wide variety of further and other embodiments all within the spirit and scope of this invention.

That which is claimed is:

1. A method for enabling the design of a multi-component system, said method comprising the steps of:
a) providing a menu of component types;
b) providing, for each of said component types, a menu of specific component objects, said specific component objects including design guideline properties;
c) selecting a component type;
d) selecting a specific component object;
e) displaying an image of said selected specific component object;
f) selecting spatial properties of said image of said selected specific component object;
g) providing data corresponding to a system design area;
h) placing said image, with the selected spatial properties, of said selected specific component object on said system design area;
i) moving said image of said selected specific component object to a desired position in said system design area;
j) establishing, if at least one other image of a specific component object is present in said system design area, a relationship between said image of said selected specific component object and one other image of a specific component object, said relationship incorporating said design guideline properties;
k) repeating steps c) through j) until a design of the multi-component system is completed.

2. The method of claim 1 further comprising the step of:
1) storing, upon completion of said design of the multi-component system, system design data including a plurality of specific component objects, an object list including an identifier for each one of said plurality of specific component objects, a location in said system design area for each one of said plurality of specific component objects, data corresponding to the system design area, data corresponding to a user of said method.

3. The method of claim 1 further comprising the step of:
m) retrieving, from a storage location, a plurality of identifiers corresponding to a plurality of specific component objects, a location in a retrieved system design area for each one of said plurality of specific component objects, data corresponding to said retrieved system design area.

4. The method of claim 1 further comprising the step of:
n) notifying a predetermined recipient after completion of said design of the multi-component system.

5. The method of claim 1 further comprising the step of carrying out the method in a distributed environment.

6. The method of claim 5 wherein said distributed environment is the World Wide Web.

7. The method of claim 2 further comprising the step of carrying out the method in a distributed environment.

8. The method of claim 7 wherein said distributed environment is the World Wide Web.

9. The method of claim 3 further comprising the step of carrying out the method in a distributed environment.

10. The method of claim 9 wherein said distributed environment is the World Wide Web.

11. The method of claim 1 further comprising the step of:
n) documenting said design of the multi-component system.

12. The method of claim 4 further comprising the step of carrying out the method in a distributed environment.

13. The method of claim 12 wherein said distributed environment is the World Wide Web.

14. The method of claim 1 wherein the step of placing said image, said user input comprises a click-and-drag operation.

15. A system for enabling the design of a multi-component product, said system comprising:
means for providing a menu of component types;
means for providing, for each of said component types, a menu of specific component objects, said specific component objects including design guideline properties;
means for receiving user input;
means for selecting a component type;
means for selecting a specific component object;
means for displaying an image of said selected specific component object;
means for selecting an orientation of said image of said selected specific component object;
means for providing data corresponding to a system design area;
means for placing, in the selected orientation said image of said selected specific component object on said system design area;
means for moving said image of said selected specific component object to a desired position in said system design area;
means for establishing, if at least one other image of a selected specific component object is present in said system design area, a relationship between said image of said selected specific component object and one other image of a specific component object, said relationship incorporating said design guideline properties.

16. The system of claim 14 further comprising:
means for storing, upon completion of said design of the multi-component system, system design data including a plurality of specific component objects, an object list including an identifier for each one of said plurality of specific component objects, a location in said system design area for each one of said plurality of specific component objects, a plurality of descriptions of relationships between images of the specific component objects, data corresponding to the system design area, data corresponding to a user of said method.

17. The system of claim 14 further comprising:
means for retrieving, from a storage location, a plurality of identifiers of specific component objects, a location in said system design area for each one of a plurality of specific component objects, said plurality of identifiers of specific component objects corresponding to said plurality of specific component objects.

18. The system of claim 14 further comprising:
means for notifying a predetermined recipient upon completion of said design of the multi-component system.

19. The system of claim 14 further comprising:
means for documenting said design of the multi-component system.

20. An apparatus comprising:
at least one server computer including:
an interface for communicating over a network,
a multi-component system design generating module including specific component objects, said specific component objects including design guidelines;
a database storing user identifying data, design identifying data, multi-component system design data including a plurality of identifiers of specific component objects, a location in said system design area for each one of a plurality of specific component objects, said plurality of identifiers of specific component objects corresponding to said plurality of specific component objects.

21. The apparatus of claim 18 wherein said at least one server computer further includes:
a user identification module.

22. A computer readable product comprising:
a computer usable medium having computer readable data embodied therein, said data including:
user identifying data,
design identifying data,
multi-element system design data including:
a plurality of identifiers of specific component objects,
a location in a system design area of each one of a plurality of specific component objects, said plurality of specific component objects corresponding to said plurality of identifiers of specific component objects.

23. The computer readable product of claim 22 further comprising:
a computer usable medium having computer readable code embodied therein, said code causing a server computer system to:
provide a multi-element system design generating component.

24. The computer readable product of claim 23 wherein said multi-element system design generating component causes a computer system to:
provide a menu of component types;
provide, for each of said component types, a menu of specific component objects, said specific component objects including design guideline properties;
select a component type;
select a specific component object;
display an image of said selected specific component object;
select an orientation of said image of said selected specific component object;
accept data corresponding to a system design area;
place said image of said selected specific component object on said system design area;
move said image of said selected specific component object to a desired position in said system design area;
establish, if at least one other image of a selected specific component object is present in said system design area, a relationship between said image of said selected specific component object and one other image of a selected specific component object, said relationship incorporating said design guideline properties.

25. The computer readable product of claim 22 wherein said code further causes a server computer system to:
store, in a computer usable medium, data corresponding to the system design area, data corresponding to a user of said method, and an object list including an identifier for each one of a plurality of specific component objects, a location in a system design area for each one of said plurality of specific component objects.

26. The computer readable product of claim 24 wherein said code further causes a server computer system to:
provide, to a client computer, a plurality of identifiers of specific component objects, a location in a provided system design area for each one of a plurality of specific component objects, data corresponding to said provided system design area, said plurality of identifiers of specific component objects corresponding to said plurality of specific component objects.

27. The computer readable product of claim 23 wherein said code further causes a server computer system to:
notify a predetermined recipient upon completion of a design of the multi-component system.

28. The computer readable product of claim 23 wherein said code further causes a server computer system to:
document a design of the multi-component system.

29. A memory for storing data for access by a process executed by a processor, said memory comprising:
a structure for describing a design of a multi-component system, said structure comprising:
user identifying data,
design identifying data,
multi-component system design data including:
an identifier for each one of a plurality of specific component objects,
a location in a system design area of each one of said plurality of specific component objects,
data corresponding to said system design area,
wherein the location of said specific component objects in said system design area conforms to design guideline properties corresponding to each one of said plurality of specific component objects.
